(19) United States
(12) Patent Application Publication
(10) Pub. No.: US 2023/0258806 A1
(43) Pub. Date: Aug. 17, 2023

(54) LIDAR SYSTEM FOR DYNAMICALLY SELECTING FIELD-OF-VIEWS TO SCAN WITH DIFFERENT RESOLUTIONS

(71) Applicant: BEIJING VOYAGER TECHNOLOGY CO., LTD., Beijing (CN)

(72) Inventors: Yonghong GUO, Mountain View, CA (US); Youmin WANG, Berkeley, CA (US); Yue LU, Los Gatos, CA (US)

(73) Assignee: BEIJING VOYAGER TECHNOLOGY CO., LTD., Beijing (CN)

(21) Appl. No.: 17/677,144

(22) Filed: Feb. 22, 2022

Related U.S. Application Data
(63) Continuation-in-part of application No. 17/673,701, filed on Feb. 16, 2022.

(51) Int. Cl. G01S 17/89; G01S 7/481; G01S 7/4865

(52) U.S. Cl. CPC G01S 17/89; G01S 7/4815; G01S 7/4816; G01S 7/4865; G01S 7/4817

(57) ABSTRACT

Embodiments of the disclosure provide for a LiDAR system. The LiDAR system may dynamically select a first FOV of a far-field environment to be scanned at a rough resolution and a second FOV including important information, as indicated based on object data from a previous scanning procedure, to be scanned at a fine resolution. For example, an area-of-interest, such as along the horizon where pedestrians, vehicles, or other objects may be located, may be scanned with the finer resolution. Using fine resolution for the area-of-interest may achieve a higher-degree of accuracy/safety in terms of autonomous navigation decision-making than if coarse resolution is used. Because the use of fine resolution is limited to a relatively small area, a reasonably sized photodetector and laser power may still be used to generate a long distance, high-resolution point-cloud.

### CROSS-REFERENCE TO RELATED APPLICATION(S)

This application is a continuation-in-part of U.S. application Ser. No. 17/673,701, entitled “A LIDAR SYSTEM FOR CAPTURING DIFFERENT FIELD-OF-VIEWS WITH DIFFERENT RESOLUTIONS” and filed on Feb. 16, 2022, which is expressly incorporated by reference herein in its entirety.

### TECHNICAL FIELD

The present disclosure relates to a Light Detection and Ranging (LiDAR) system, and more particularly to, a LiDAR system configured to dynamically select a first field-of-view (FOV) to scan with low-resolution and a second FOV that encompasses an area-of-interest to scan with high-resolution.

### BACKGROUND

Optical sensing systems, e.g., such as LiDAR systems, have been widely used in advanced navigation technologies, such as to aid autonomous driving or to generate high-definition maps. For example, a typical LiDAR system measures the distance to a target by illuminating the target with pulsed laser light beams that are steered towards an object in the far field using a scanning mirror, and then measuring the reflected pulses with a sensor. Differences in laser light return times, wavelengths, and/or phases (also referred to as “time-of-flight (ToF) measurements”) can then be used to construct digital three-dimensional (3D) representations of the target. Because using a narrow laser beam as the incident light can map physical features with a high-degree of accuracy, a LiDAR system is particularly suitable for applications such as sensing in autonomous driving and high-definition map surveys.

To scan the narrow laser beam across a broad field-of-view (FOV) in two-dimensions (2D), conventional systems generally use one of a flash or scanning LiDAR. In flash LiDAR, the entire FOV is illuminated with a wide, diverging laser beam in a single pulse. This is in contrast to scanning LiDAR, which uses a collimated laser beam that illuminates one point at a time, and the beam is raster scanned to illuminate the FOV point-by-point.

Using conventional systems to construct a point-cloud with a large FOV, a high-resolution, and from a long distance presents various challenges, however. For example, a 120° (horizontal)×30° (vertical) FOV point-cloud with a resolution of 0.01° would have thirty-six million points. It may be difficult or impossible to achieve a point cloud of this size and resolution using existing flash or scanning LiDAR systems. This is because the detector array of existing flash LiDAR systems lacks the requisite number of pixels, and conventional scanning LiDAR systems are unable to scan this many points within a short (e.g., the 100 milliseconds (ms)) scanning period for an entire FOV.

Another challenge in constructing the above-mentioned point-cloud relates to the requisite laser power. The amount of laser power received by a single pixel decreases as the number of pixels in a photodetector increases. Thus, to increase a point-cloud resolution from 0.1° to 0.01°, the number of pixels in the photodetector array would need to be increased by a factor of one-hundred, while the amount of laser power received by a single pixel would be decreased by a factor of one-hundred. A reduced laser power per pixel significantly impacts the detection accuracy due to, e.g., a lower signal-to-noise (SNR) ratio. Moreover, the detection range of a LiDAR system decreases as resolution increases. For example, a system with a resolution ten-times higher has a detection range ten-times shorter, assuming the same laser power.

Thus, there exists an unmet need for a LiDAR system that can cover a larger FOV at a lower resolution and a smaller FOV at a higher resolution, as compared with conventional systems.

### SUMMARY

Embodiments of the disclosure provide for a LiDAR system. The LiDAR system may include a first transmitter subsystem and a second transmitter subsystem. The LiDAR system may include a controller coupled to the first transmitter subsystem and the second transmitter subsystem. The controller may be configured to identify a first FOV to be scanned and a second FOV within the first FOV. The second FOV may be associated with an area-of-interest. The controller may be configured to cause the first transmitter subsystem to scan the first FOV using a first resolution during a first optical sensing procedure. The controller may be configured to cause the second transmitter subsystem to scan the second FOV using a second resolution during a second optical sensing procedure, the second resolution being finer than the first resolution. The LiDAR system may include at least one photodetector configured to detect light returned from the first FOV scanned during the first optical sensing procedure and light returned from the second FOV scanned during the second optical sensing procedure. The LiDAR system may include a signal processor coupled to the at least one photodetector and configured to generate point cloud data based on the light returned from the first FOV and the second FOV and detected by the at least one photodetector.

Embodiments of the disclosure also provide for a transmitter for a LiDAR system. The transmitter may include a first transmitter subsystem and a second transmitter subsystem. The transmitter may include a controller coupled to the first transmitter subsystem and the second transmitter subsystem. The controller may be configured to identify a first FOV to be scanned and a second FOV within the first FOV. The second FOV may be associated with an area-of-interest. The controller may be configured to cause the first transmitter subsystem to scan the first FOV using a first resolution during a first optical sensing procedure. The controller may be configured to cause the second transmitter subsystem to scan the second FOV using a second resolution during a second optical sensing procedure, the second resolution being finer than the first resolution.

Embodiments of the disclosure further provide for a method for operating a LiDAR system. The method may include identifying, by a controller, a first field-of-view (FOV) to be scanned and a second FOV within the first FOV. The second FOV may be associated with an area-of-interest. The method may include causing, by the controller, a first transmitter subsystem to scan the first FOV using a first resolution during a first optical sensing procedure. The method may include causing, by the controller, a second transmitter subsystem to scan the second FOV using a second resolution during a second optical sensing procedure, the second resolution being finer than the first resolution. The method may include detecting, by at least one photodetector, light returned from the first FOV scanned during the first optical sensing procedure and light returned from the second FOV scanned during the second optical sensing procedure. The method may include generating, by a signal processor, point cloud data based on the light returned from the first FOV and the second FOV and detected by the at least one photodetector.

It is to be understood that both the foregoing general description and the following detailed description are exemplary and explanatory only and are not restrictive of the invention, as claimed.

### BRIEF DESCRIPTION OF THE DRAWINGS

FIG. 1A illustrates a block diagram of an exemplary LiDAR system, according to embodiments of the disclosure.

FIG. 1B illustrates a diagram of a first pair of exemplary rough-resolution and fine-resolution FOVs identified by a controller, according to embodiments of the disclosure.

FIG. 1C illustrates a diagram of a second pair of exemplary rough-resolution and fine-resolution FOVs identified by a controller based on object information obtained by scanning the first pair of rough-resolution and fine-resolution FOVs depicted in FIG. 1B, according to embodiments of the disclosure.

FIG. 2A illustrates a first exemplary scanning pattern performed using one-dimensional (1D) flash, a 1D horizontal scanner, and a 1D photodetector array to capture a large FOV with rough resolution, according to embodiments of the disclosure.

FIG. 2B illustrates a second exemplary scanning pattern performed using a 1D vertical microelectricalmechanical system (MEMS) scanner, a 1D horizontal scanner, and a single photodetector to capture a large FOV with rough resolution, according to embodiments of the disclosure.

FIG. 2C illustrates a third exemplary scanning pattern performed using a 1D vertical MEMS scanner, a 1D horizontal scanner, and a 1D photodetector array to capture a large FOV with rough resolution, according to embodiments of the disclosure.

FIG. 3A illustrates a fourth exemplary scanning pattern performed using a two-dimensional (2D) flash, a 1D horizontal scanner, and a 2D photodetector array to capture a small FOV with fine resolution, according to embodiments of the disclosure.

FIG. 3B illustrates a fifth exemplary scanning pattern performed using 1D vertical MEMS scanner, a 1D horizontal scanner, and a 1D photodetector array to capture a small FOV with fine resolution, according to some embodiments of the disclosure.

FIG. 3C illustrates a sixth exemplary scanning pattern performed using a 2D MEMS scanner and a single photodetector to capture a small FOV with fine resolution, according to some embodiments of the disclosure.

FIG. 4 illustrates a flow chart of an exemplary method for operating a LiDAR system, according to embodiments of the disclosure.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

LiDAR is an optical sensing technology that enables autonomous vehicles to “see” the surrounding world, creating a virtual model of the environment to facilitate decision-making and navigation. An optical sensor (e.g., LiDAR transmitter and receiver) creates a 3D map of the surrounding environment using laser beams and time-of-flight (ToF) distance measurements. ToF, which is one of LiDAR's operational principles, provides distance information by measuring the travel time of a collimated laser beam to reflect off an object and return to the sensor. Reflected light signals are measured and processed at the vehicle to detect, identify, and decide how to interact with or avoid objects.

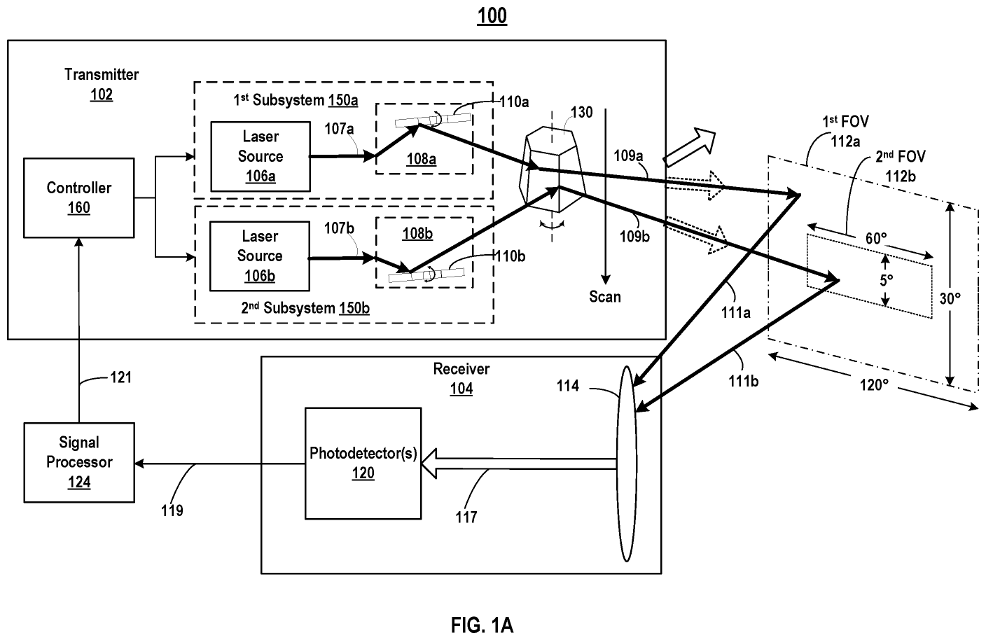

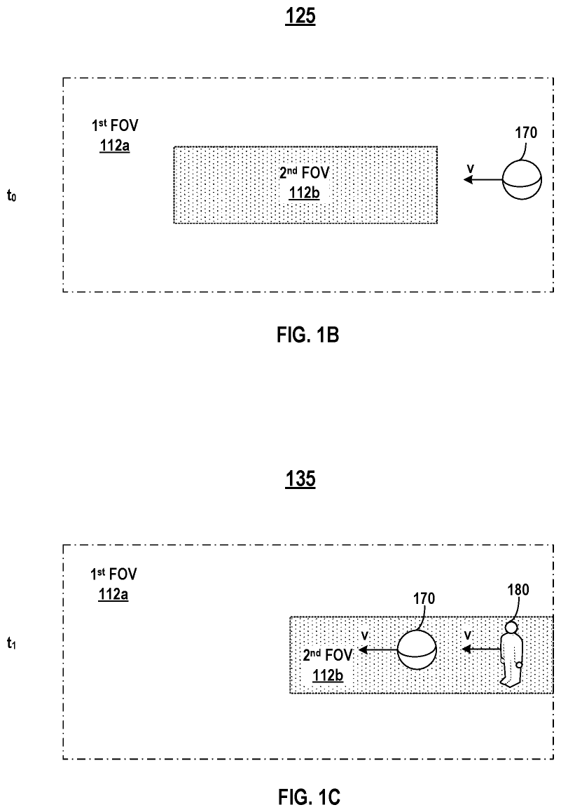

Due to the challenges imposed by existing Li DAR systems, as discussed above in the BACKGROUND section, the present disclosure provides an exemplary LiDAR system that selectively captures two FOVs of different sizes at different resolutions. The size and location of the FOVs may be identified based on object data obtained from previous optical sensing procedures. The rough-resolution FOV may be large in size, while the fine-resolution FOV may be comparatively smaller. For an area-of-interest, such as along the horizon where pedestrians, vehicles, or other objects may be located/moving, the fine-resolution FOV may be used. Moreover, object data obtained from a first pair of rough-resolution and fine-resolution FOVs scanned at a first time may be used to identify a second pair of rough-resolution and fine-resolution FOVs to scan at a second time. For instance, when a controller identifies a ball kicked into the street based on object data obtained from a rough-resolution FOV scanned during a first scanning procedure, the controller may use this object data to identify a new area-of-interest that includes the ball's position and/or trajectory. Thus, during a second scanning procedure, the exemplary controller may shift the position of the fine-resolution FOV so that the new area-of-interest is scanned with greater resolution. Selectively identifying different areas-of-interest to scan using fine resolution may achieve a higher-degree of accuracy in terms of object identification, and therefore, provide a higher-degree of safety in terms of autonomous navigation decision-making. For the region(s) other than the fine-resolution FOV, e.g., such as the peripheral regions away from the horizon, the rough-resolution FOV may be used. Because the use of fine resolution scanning/detecting is limited to a relatively small area, a photodetector of reasonable size and a laser beam of reasonable power may still be used to generate a long distance, high-resolution point-cloud for the second FOV. Additional details of the exemplary LiDAR system are provided below in connection with FIGS. 1A-4.

Some exemplary embodiments are described below with reference to a transmitter used in LiDAR system(s), but the application of the multi-resolution transmitter disclosed by the present disclosure is not limited to the LiDAR system. Rather, one of ordinary skill would understand that the following description, embodiments, and techniques may apply to any type of optical sensing system (e.g., biomedical imaging, 3D scanning, tracking and targeting, free-space optical communications (FSOC), and telecommunications, just to name a few) known in the art without departing from the scope of the present disclosure.

FIG. 1A illustrates a block diagram of an exemplary LiDAR system 100, according to embodiments of the disclosure. FIG. 1B illustrates a diagram of a first pair 125 of exemplary rough-resolution and fine-resolution FOVs identified by an exemplary controller included in LiDAR system 100, according to embodiments of the disclosure. FIG. 1C illustrates a diagram of a second pair 135 of exemplary rough-resolution and fine-resolution FOVs identified by the exemplary controller included in LiDAR system 100 based on object information obtained from the first pair 125 of rough-resolution and fine-resolution FOVs depicted in FIG. 1B, according to some embodiments of the disclosure. FIGS. 1A-1C will be described together.

Referring to FIG. 1A, LiDAR system 100 may include a transmitter 102 and a receiver 104. Transmitter 102 may emit laser beams along multiple directions using different transmitter subsystems for different FOVs. For example, transmitter 102 may include a first transmitter subsystem 150a used to scan first FOV 112a with a first resolution (e.g., low-resolution) and a second transmitter subsystem 150 used to scan second FOV 112b with a second resolution (e.g., high-resolution). Second FOV 112b may include an area-of-interest, e.g., such as along the horizon where pedestrians, vehicles, or other objects may be located/moving. As mentioned above, using fine resolution for the area-of-interest may achieve a higher-degree of accuracy in terms of object identification, and therefore, provide a higher-degree of safety in terms of autonomous navigation decision-making. Transmitter 102 may include a controller 160 that dynamically selects the sizes and locations of first FOV 112a and second FOV 112b. The selection can be made through user interaction (e.g., user input information of an area-of-interest) or automatically based on object data obtained from a previous scanning procedure. Additional details of the dynamic FOV selection procedure performed controller 160 are provided below in connection with FIGS. 1B and 1C.

As illustrated in FIG. 1A, when implemented using scanning LiDAR, transmitter 102 can sequentially emit a stream of pulsed laser beams in different directions within a scan range (e.g., a range of scanning angles in angular degrees). First laser source 106a may be configured to emit a first laser beam 107a (also referred to as “native laser beam”) to first scanner 108a, while second laser source 106b may be configured to emit a second laser beam 107b to second scanner 108b. First laser source 106a and first scanner 108a may make up a first transmitter subsystem 150a. Second laser source 106b and second scanner 108 may make up a second transmitter subsystem 150b. In some embodiments, first laser source 106a and second laser source 106b may each generate a pulsed laser beam in the UV, visible, or near infrared wavelength range. First laser beam 107a may diverge in the space between first laser source 106a and first scanner 108a. Similarly, second laser beam 107b may diverge in the space between second laser source 106b and second scanner 108b. Thus, although not illustrated, transmitter 102 may further include a first collimating lens located between first laser source 106a and first scanner 108a and a second collimating lens located between second laser source 106b and second scanner 108b. Each of the collimating lenses may be configured to collimate divergent first laser beam 107a and divergent second laser beam 107b before they impinge on first scanner 108a and second scanner 108b, respectively. Although the transmitter subsystems in FIG. 1A are depicted as including scanners, the implementation of the transmitter subsystems is not limited thereto. Instead, one or more of first transmitter subsystem 150a and/or second transmitter subsystem 150b may be implemented using flash LiDAR technology. When flash LiDAR technology is used, the collimating lens may be omitted since its divergent laser beam (e.g., which has a vertical width that covers the vertical width of the FOV) is scanned across different horizontal angles.

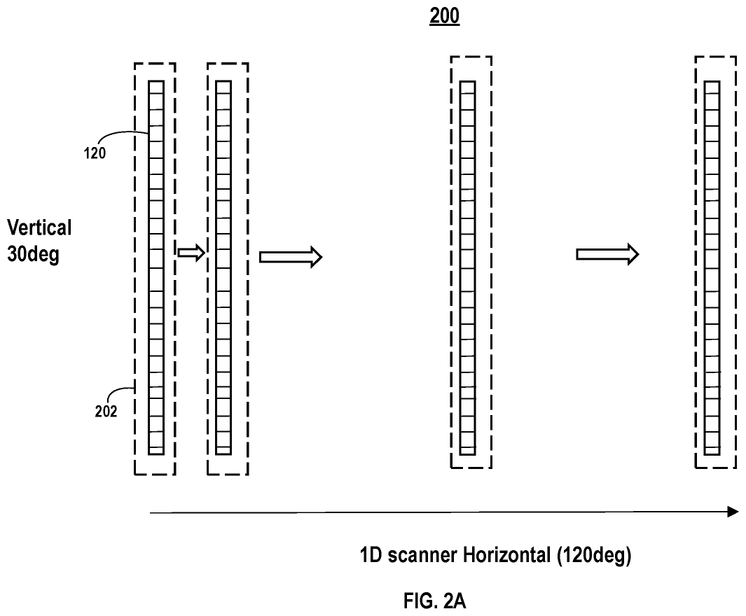

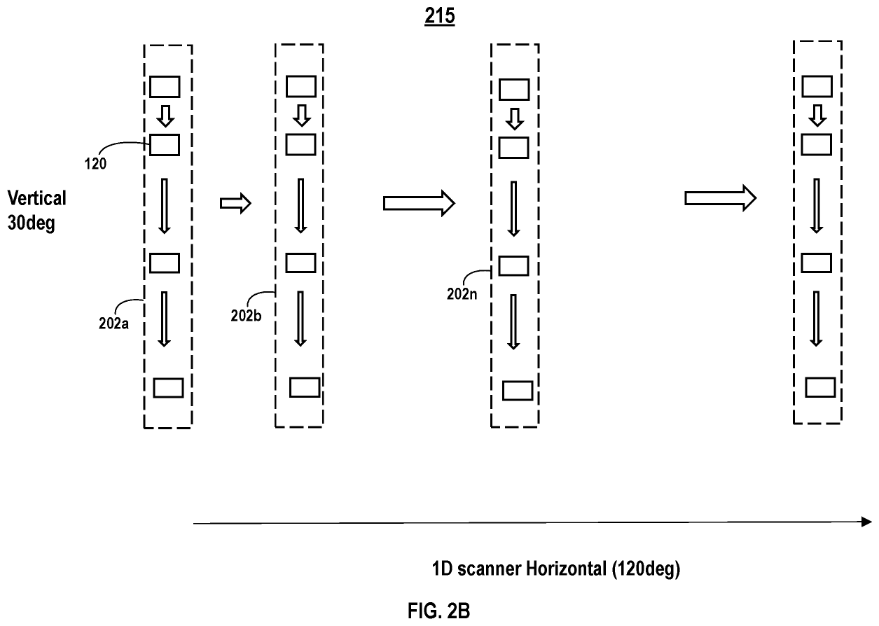

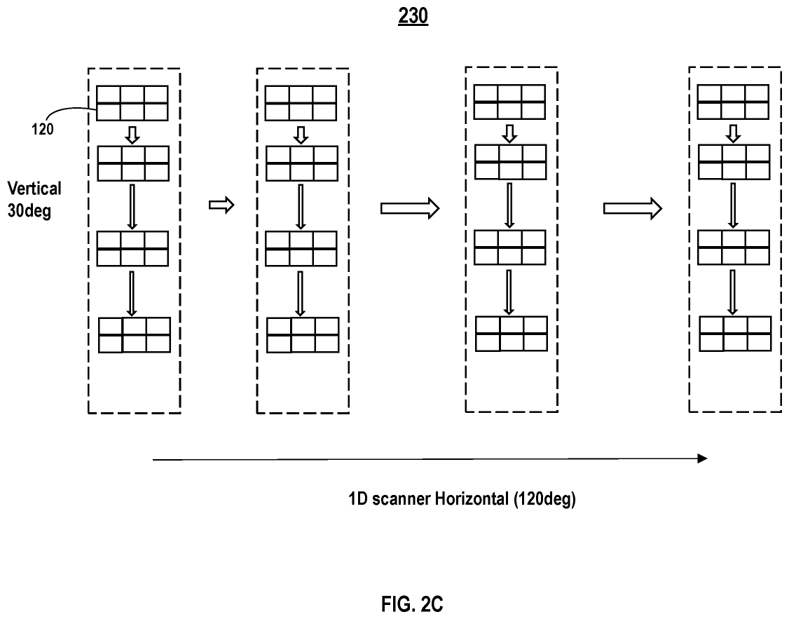

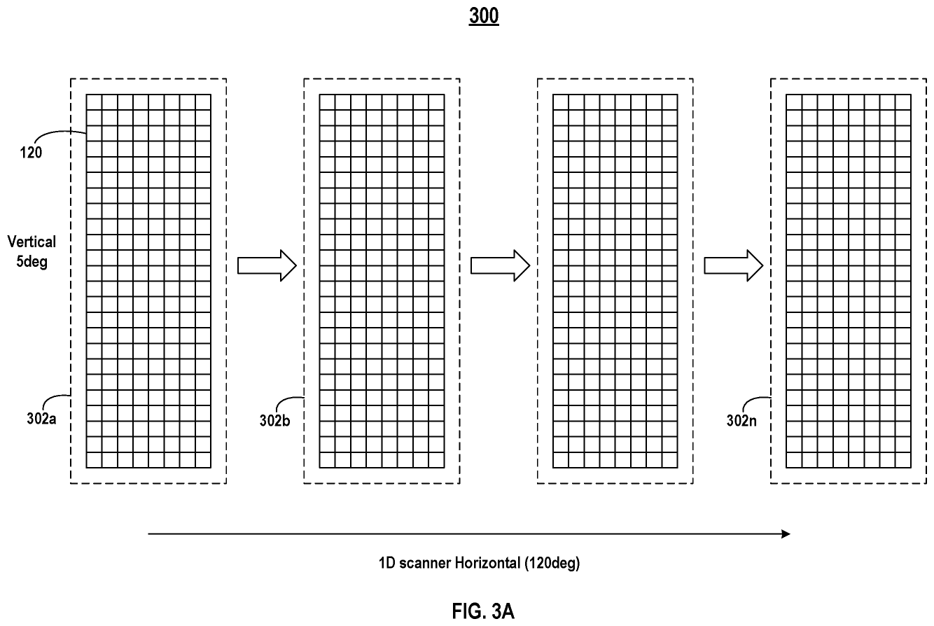

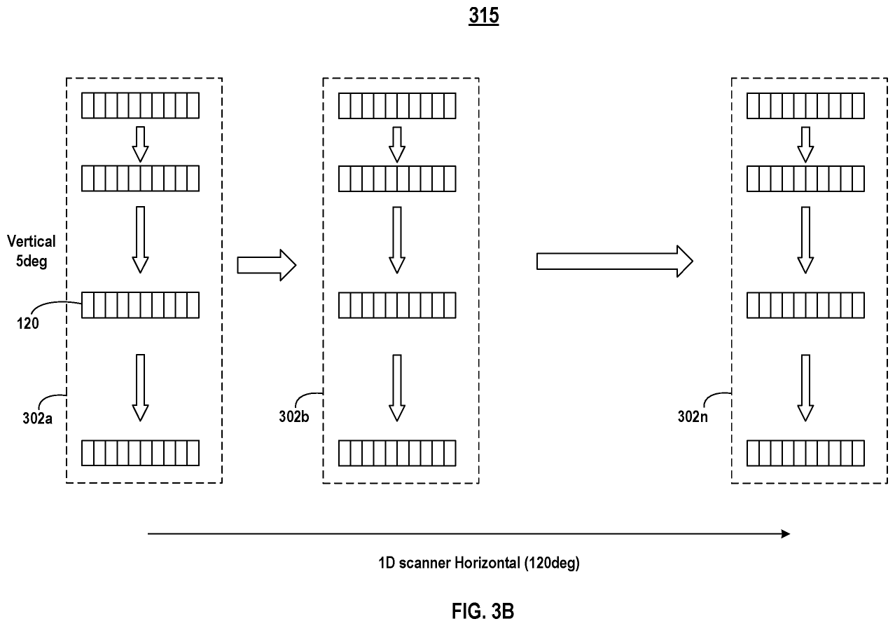

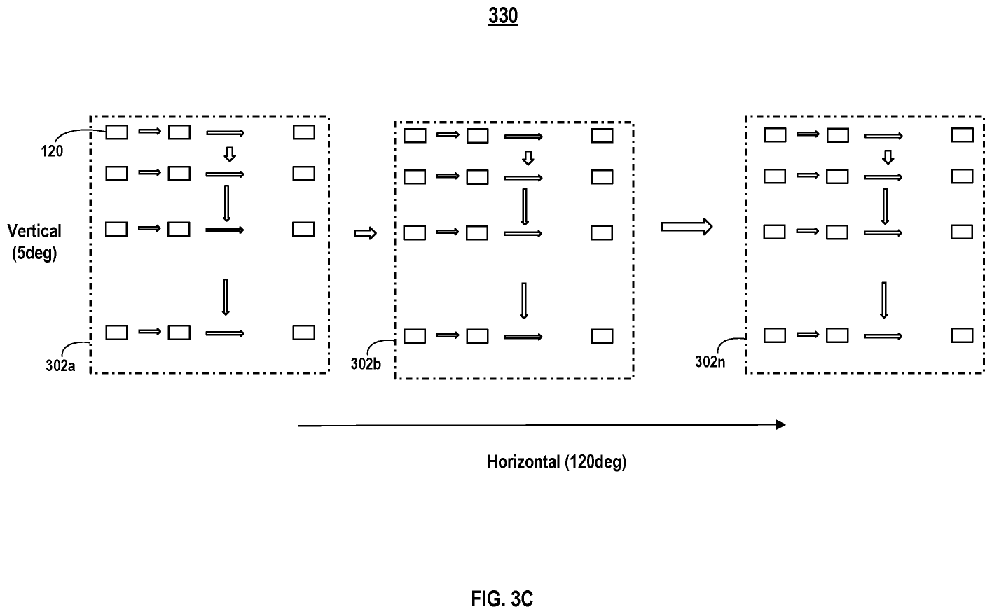

Furthermore, the transmitter subsystem may not include a scanner when flash LiDAR is used. For example, when first transmitter subsystem 150a is configured to perform the first exemplary scanning pattern 200 depicted in FIG. 2A, first scanner 108a and the collimating lens may be omitted. Here, the vertical width of first laser beam 107a may span the vertical width of first FOV 112a and only a portion of the horizontal width of first FOV 112a. Thus, during a first scanning procedure for first FOV 112a, the mechanical scanner (e.g., polygon scanner 130 in FIG. 1A) may steer the vertical line (e.g., third laser beam 109a) to a different horizontal position until first FOV 112a has been scanned in its entirety. Similarly, when second transmitter subsystem 150b is configured to perform the fourth exemplary scanning pattern 300 depicted in FIG. 3A, second scanner 108b and collimating lens may be omitted. Here, the vertical width of second laser beam 107b may span the vertical width of second FOV 112b and a portion of the horizontal width of second FOV 112b. Thus, during the second scanning procedure for second FOV 112b, the mechanical scanner (e.g., polygon scanner 130 in FIG. 1A) may steer the vertical line (e.g., fourth laser beam 109b) to a different horizontal position until second FOV 112b has been scanned in its entirety. First transmitter subsystem 150a may be configured to perform any one of the exemplary scanning patterns 200, 215, 230 depicted in FIGS. 2A-2C. Second transmitter subsystem 150b may be configured to perform any one of the exemplary scanning patterns 300, 315, 330 depicted in FIGS. 3A-3C.

In some embodiments of the present disclosure, first laser source 106a and second laser source 106b may include a pulsed laser diode (PLD), a vertical-cavity surface-emitting laser (VCSEL), a fiber laser, etc. For example, a PLD may be a semiconductor device similar to a light-emitting diode (LED) in which the laser beam is created at the diode's junction. In some embodiments of the present disclosure, a PLD includes a PIN diode in which the active region is in the intrinsic (I) region, and the carriers (electrons and holes) are pumped into the active region from the N and P regions, respectively. Depending on the semiconductor materials, the wavelength of incident laser beam 107 provided by a PLD may be greater than 700 nm, such as 760 nm, 785 nm, 808 nm, 848 nm, 905 nm, 940 nm, 980 nm, 1064 nm, 1083 nm, 1310 nm, 1370 nm, 1480 nm, 1512 nm, 1550 nm, 1625 nm, 1654 nm, 1877 nm, 1940 nm, 2000 nm, etc. It is understood that any suitable laser source may be used as first laser source 106a for emitting first laser beam 107a and second laser source 106b for emitting second laser beam 107b.

When first transmitter subsystem 150a is implemented using scanning LiDAR technology, first scanner 108a may be configured to steer a third laser beam 109a towards an object (e.g., stationary objects, moving objects, people, animals, trees, fallen branches, debris, metallic objects, non-metallic objects, rocks, rain, chemical compounds, aerosols, clouds and even single molecules, just to name a few) in a direction within a range of scanning angles of first FOV 112a. Similarly, when second transmitter subsystem 150b is implemented using scanning LiDAR technology, second scanner 108b may be configured to steer a fourth laser beam 109b towards an object in a direction within a range of scanning angles associated with second FOV 112b. First FOV 112a may have a vertical width in the range of 10° to 45°, a horizontal width in the range of 30° to 360°, and the resolution associated with first FOV 112a may be in the range of 0.05° to 0.5°. Second FOV 112b may have a vertical width in the range of 2° to 10°, a horizontal width in the range of 30° to 360°, and the resolution associated with second FOV 112b may be in the range of 0.005° to 0.1°, for instance. The vertical and horizontal widths and the resolutions described above for first FOV 112a and second FOV 112b are provided by way of example and not limitation. It is understood that other vertical and horizontal widths and resolutions may be used without departing from the scope of the present disclosure.

In some embodiments consistent with the present disclosure, first scanner 108a and second scanner 108b may include a micromachined mirror assembly, e.g., such as first scanning mirror 110a and second scanning mirror 110b. First scanning mirror 110a and second scanning mirror 110b may each be a microelectricalmechanical (MEMS) mirror. In some embodiments, first scanning mirror 110a and/or second scanning mirror 110b may be configured to resonate during the scanning procedure. Although not shown in FIG. 1A, the planar mirror assemblies of first scanner 108a and second scanner 108b may also include various other elements. For example, these other elements may include, without limitation, a MEMS actuator, actuator anchor(s), a plurality of interconnects, scanning mirror anchor(s), just to name a few.

In some embodiments consistent with the present disclosure, transmitter 102 may include a mechanical scanner configured to steer third laser beam 109a in a horizontal scanning direction associated with first FOV 112a and fourth laser beam 109b in a horizontal scanning direction associated with second FOV 112b. In some embodiments, the mechanical scanner may include a polygon mirror assembly that includes polygon scanner 130. Although not shown in FIG. 1A, polygon scanning assembly may include a driver mechanism configured to rotate polygon scanner 130 about its longitudinal axis during the scanning procedure. However, the mechanical scanner is not limited to a polygon scanning assembly. Instead, the mechanical scanner may include any type of mechanical scanning assembly known in the art without departing from the scope of the present disclosure. For example, a galvanometer may be used instead of a polygon scanning assembly. The mechanical scanner may be shared by first transmitter subsystem 150a and second transmitter subsystem 150b. Thus, the mechanical scanner may be considered part of each of the transmitter subsystems 150a, 150b. However, in some embodiments, e.g., such as when one of the transmitter subsystems includes a 2D MEMS scanner, the mechanical scanner may not be used by that transmitter subsystem and not considered a part thereof.

In some embodiments, receiver 104 may be configured to detect a first returned laser beam 111a returned from first FOV 112a and a second returned laser beam 111b returned from second FOV 112b. First returned laser beam 111a may be returned from an object located in first FOV 112a and have the same wavelength as third laser beam 109a. Second returned laser beam 111b may be returned from an object located in second FOV 112b and have the same wavelength as fourth laser beam 109b. First returned laser beam 111a may be in a different direction from third laser beam 109a, and second returned laser beam 111b may be in a different direction from fourth laser beam 109b. Third laser beam 109a and fourth laser beam 109b can be reflected by one or more objects in their respective FOVs via backscattering, e.g., such as Raman scattering and/or fluorescence.

As illustrated in FIG. 1A, receiver 104 may collect the returned laser beams and output electrical signals proportional to their intensities. During a first optical sensing procedure, first returned laser beam 111a may be collected by lens 114 as laser beam 117. Similarly, during a second optical sensing procedure, second returned laser beam 111b may be collected by lens 114 as a different laser beam 117. The first optical sensing procedure and the second optical sensing procedure may be performed in a synchronized and/or coordinated fashion so that they do not interfere with each other. In other words, first returned laser beam 111a and second returned laser beam 111b are received by lens 114 at different times such that laser beam 117 does not include a mix of returned laser beams from the different FOVs. For example, a first portion of first FOV 112a may be scanned at t₀, a first portion of second FOV 112b may be scanned at t₁, a second portion of first FOV 112a may be scanned at t₂, a second portion of second FOV 112b may be scanned at t₃, and so on. In this example, t₀, t₁, t₂, and t₃ may be contiguous or non-contiguous in the time domain, depending on the implementation. Photodetector(s) 120 may convert the laser beam 117 collected by lens 114 into an electrical signal 119 (e.g., a current or a voltage signal).

In some embodiments, photodetector(s) 120 may include a single photodetector or photodetector array used for receiving laser beams returned from first FOV 112a and second FOV 112b. In some other embodiments, photodetector(s) 120 may include a first photodetector used for receiving laser beams returned from first FOV 112a and a second photodetector used for receiving laser beams returned from second FOV 112b. The type(s) of photodetector(s) 120 included in LiDAR system 100 may depend on the implementation of first transmitter subsystem 150a and second transmitter subsystem 150b. For instance, when first transmitter subsystem 150a includes 1D vertical flash and a 1D horizontal scanner, photodetector(s) 120 may include a 1D vertical line with pixelization (see FIG. 2A). In another example, when first transmitter subsystem 150a includes a 1D MEMS scanner (e.g., vertical scanner) and 1D mechanical scanner (e.g., horizontal scanner), photodetector(s) 120 may be implemented as a single photodetector without sub-pixelization (see FIG. 2B) or a single photodetector with sub-pixelization (see FIG. 2C). When second transmitter subsystem 150b includes a 2D vertical flash and 1D horizontal scanner, photodetector(s) 120 may be implemented as a 2D photodetector array (see FIG. 3A). Still further, when second transmitter subsystem 150b is implemented using a 1D vertical MEMS scanner and a 1D horizontal scanner, photodetector(s) 120 may be implemented as a 1D horizontal line with pixelization (see FIG. 3B). In yet another example, when second transmitter subsystem 150b includes a 2D MEMS scanner, photodetector(s) 120 may be implemented as a single photodetector with or without sub-pixelization (see FIG. 3C).

Regardless of the type of photodetector, an electrical signal 119 may be generated when photons are absorbed in a photodiode included in photodetector(s) 120. In some embodiments of the present disclosure, photodetector(s) 120 may include a PIN detector, a PIN detector array, an avalanche photodiode (APD) detector, a APD detector array, a single photon avalanche diode (SPAD) detector, a SPAD detector array, a silicon photo multiplier (SiPM/MPCC) detector, a SiP/MPCC detector array, or the like.

LiDAR system 100 may also include at least one signal processor 124. Signal processor 124 may include a microprocessor, a microcontroller, a central processing unit (CPU), a graphical processing unit (GPU), a digital signal processor (DSP), or other suitable data processing devices. Signal processor 124 may receive electrical signal 119 generated by photodetector(s) 120. Signal processor 124 may process electrical signal 119 to determine, for example, distance information carried by electrical signal 119. Signal processor 124 may construct a first point cloud based on the processed information carried by first returned laser beam 111a from first FOV 112a and a second point cloud based on the processed information carried by second returned laser beam 111b from second FOV 112b. The first point cloud may include a first frame, which is a 3D image of the far-field environment encompassed by first FOV 112a at a particular point in time. The second point cloud may include a second frame, which is an image of the far-field environment encompassed by second FOV 112b at a particular point in time. In this context, a frame is the object data/image captured of the far-field environment within a 2D FOV (e.g., horizontal FOV and vertical FOV).

In some embodiments, the first point cloud of first FOV 112a may be generated based on first returned laser beam 111a from each section of first FOV 112a, including the region of the far-field environment that is also encompassed by second FOV 112b. In some other embodiments, the first point cloud of first FOV 112a may be generated based on first returned laser beam 111b, excluding the region of the far-field environment encompassed by second FOV 112b. The second point cloud of second FOV 112b may be generated based solely on second returned laser beam 111b, in some embodiments. In some other embodiments, however, the second point cloud of second FOV 112b may be generated collectively based on both first returned laser beam 111a from the region in first FOV 112a corresponding to second FOV 112b and second returned laser beam 111b from second FOV 112b. Here, signal processor 124 may generate a concatenated signal by combining optical information carried by first returned laser beam 111a and returned from the region in first FOV 112a corresponding to second FOV 112b, as well as second returned laser beam 111b. By generating second point cloud using optical information carried by all laser beams returned from the region corresponding to second FOV 112b during the first and second optical sensing procedures, the second point cloud may be generated with a higher-degree of accuracy than if only second returned laser beam 111b were used. In some embodiments, to concatenate first returned laser beam 111a and second returned laser beam 111b to generate the second point cloud for second FOV 112b, various technologies may be used, such as multi-resolution signal fusion methods, or learning-based methods.

As mentioned above, transmitter 102 may include controller 160, which is coupled to signal processor 124, first transmitter subsystem 150a, and second transmitter subsystem 150b. Prior to or at the start of a new scanning procedure, controller 160 may select the respective sizes and locations of first FOV 112a and second FOV 112b. The size and location of the two FOVs may be dynamically selected based on user interaction (e.g., user input of an area-of-interest) or automatically based on object data 121 (e.g., point cloud information) obtained during one or more previous scanning procedure(s). FIG. 1B and FIG. 1C illustrate examples of FOV determination based on object detection.

Referring to FIG. 1B, the size and location of first FOV 112a and second FOV 112b scanned during a first scanning procedure are depicted. As shown, second FOV 112b occupies a position in the center of first FOV 112a and corresponds to the area-of-interest during a first scanning procedure. In the present example, controller 160 may identify an object 170 based on object data 121 captured in the first point cloud of first FOV 112a. Once identified, controller 160 may further determine whether object 170 meets one or more object criteria. When object 170 meets one or more object criteria, controller 160 may dynamically select a size and/or position second FOV 112b so that the new area-of-interest is scanned with greater resolution in a subsequent scanning procedure. In some embodiments, the object criteria may indicate or suggest the object is a target of interest, such as a human being or an animal, or a dynamic event or activity of object that is worth monitoring or tracking, such as a safety-impacting event. For example, the object criteria that may cause controller 160 to dynamically select and scan second FOV 112b at a finer resolution in a subsequent scanning procedure includes one or more of, e.g., an object type (e.g., a ball, a bicycle, a skateboard, a wheelchair, crutches, construction equipment, a pedestrian, a child, a senior citizen, an animal, a vision impaired person, etc.), an object acceleration that meets an acceleration threshold condition (e.g., the acceleration threshold condition may be met when the acceleration of object 170 meets or exceeds an acceleration threshold), an object velocity that meets a velocity threshold condition (e.g., the velocity threshold condition may be met when the velocity of object 170 meets or exceeds a velocity threshold), a movement that meets a movement condition (e.g., a non-regular driving pattern, an erratic driver, an inebriated driver, an aggressive driver, a student driver etc.), just to name a few.

Moreover, controller 160 may perform object detection and/or motion detection based on image frames included in object data 121. For example, controller 160 may determine based on a group of pixels that share, e.g., the same or similar color, brightness, depth, etc., and the corresponding shape formed by those pixels, that object 170 is a ball. Moreover, based on the length of a scanning procedure and the position of those pixels associated with object 170 in first FOV 112a, controller 160 may estimate one or more of the acceleration, velocity, position, and/or trajectory of the ball. In some embodiments, controller 160 may determine whether the one or more object criteria are met by evaluating the object data from multiple scanning procedures performed at a sequence of time points. This may be useful when estimating the acceleration, velocity, and/or trajectory of object 170.

In some examples, to identify object 170 and determine whether it meets one or more of the object criteria, controller 160 may input object data 121 into a convolutional neural network and/or apply machine learning to object data 121. The convolutional neural network may generate a set of feature maps based on object data 121. Each feature map may be associated with a different one of the object criteria. For example, a first feature map may be used to identify the object type (e.g., a ball, a bicycle, a skateboard, a wheelchair, crutches, construction equipment, a pedestrian, a child, a senior citizen, an animal, a vision impaired person, etc.), a second feature map may be used to identify an acceleration of object 170, a third feature map may be used to identify a velocity of object 170, a fourth feature map may be used to identify a position of object 170, a fifth feature map may be used to identify a trajectory of object 170, etc. Thus, controller 160 may determine whether the one or more object criteria are met based on the feature map(s) output by the convolutional neural network, according to some embodiments consistent with the disclosure.

By way of example and not limitation, assume object 170 depicted in FIG. 1B is identified as a ball and that a ball is an object type that meets the object criteria. In this example, controller 160 may determine the position or the predicted position/trajectory of object 170 during the next scanning procedure. The area in and/or around the ball (e.g., position information) may be identified as an area-of-interest by controller 160. Thus, controller 160 may dynamically select the size and/or position of second FOV 112b to encompass the new area-of-interest in the subsequent scanning procedure, as shown in FIG. 1C. Controller 160 may send a signal instructing first transmitter subsystem 150a to scan first FOV 112a with the size and position depicted in FIG. 1C. Controller 160 may also send a signal instructing second transmitter subsystem 150b to scan second FOV 112b with the size and position depicted in FIG. 1C. Because a child 180 may dart into the street to retrieve object 170 (e.g., a ball), shifting the position of second FOV 112b so that the region of the far-field environment encompassing object 170 may enable scanning of the area-of-interest with greater resolution, thereby increasing the safety and accuracy of autonomous driving safety protocols and decision-making.

Although signal processor 124 and controller 160 are depicted as separate components in FIG. 1A, the architecture of LiDAR system 100 is not limited thereto. Instead, controller 160 may be considered part of signal processor 124. In this context, controller 160 may be considered part of receiver 104. In some other embodiments, signal processor 124 and controller 160 may be separate components with controller 160 being included in receiver 104. In some other embodiments, signal processor 124 may be configured to perform the above-described operations of controller 160 described above and controller 160 may be omitted from LiDAR system 100.

Moreover, the present disclosure provides various combinations of transmitter subsystem types and photodetector types that achieve long-range, high-resolution imaging of second FOV 112b without the need for photodetector(s) 120 to be made up of an undue number of pixels. Additional details of these combinations are described below in connection with FIGS. 2A-2C and 3A-3C.

FIG. 2A illustrates a first exemplary scanning pattern 200 performed using a 1D vertical flash, a 1D horizontal scanner, and a 1D detector array to capture first FOV 112a of FIG. 1A with rough resolution, according to embodiments of the disclosure. FIG. 2B illustrates a second exemplary scanning pattern 215 performed using a 1D vertical MEMS scanner, a 1D horizontal scanner, and a single detector to capture first FOV 112a of FIG. 1A with rough resolution, according to embodiments of the disclosure. FIG. 2C illustrates a third exemplary scanning pattern 230 performed using a 1D vertical MEMS scanner, a 1D horizontal scanner, and a 1D detector array to capture first FOV 112a with rough resolution, according to embodiments of the disclosure. FIG. 3A illustrates a fourth exemplary scanning pattern 300 performed using 2D vertical flash, a 1D horizontal scanner, and a 2D photodetector array to capture second FOV 112b with fine resolution, according to embodiments of the disclosure. FIG. 3B illustrates a fifth exemplary scanning pattern 315 performed using 1D vertical MEMS scanner, a 1D horizontal scanner, and a 1D photodetector array to capture second FOV 112b of FIG. 1A with fine resolution, according to some embodiments of the disclosure. FIG. 3C illustrates a sixth exemplary scanning pattern performed using a 2D MEMS scanner and a single photodetector to capture second FOV 112b of FIG. 1A with fine resolution, according to some embodiments of the disclosure. FIGS. 2A-2C and 3A-3C will be described together with reference to FIG. 1A.

Referring to FIGS. 1A and 2A, first FOV 112a may be scanned using a 1D vertical flash and a 1D horizontal scanner. In this embodiment, first laser source 106a may emit first laser beam 107a as a flash. Rather than emitting a point of light, first laser beam 107a may have a vertical width that spans the vertical width of first FOV 112a. When 1D vertical flash is used, first transmitter subsystem 150a may not include first scanner 108a or first scanning mirror 110a in FIG. 1A. During a first optical sensing procedure, first laser source 106a may emit a single flash pulse during each cycle to scan first FOV 112a. Then, the mechanical scanner (e.g., polygon scanner 130, galvanometer, etc.) steers the flash pulse so that it illuminates a different horizontal slice 202 until first FOV 112a is fully scanned. Moreover, in this example, photodetector array(s) 120 may be a 1D detector array (e.g., a column of 300 pixels) that forms a single line that has the same or smaller dimensions as returned laser beam 111a.

Referring to FIGS. 1A, 2B, and 2C, first FOV 112a may be scanned using 1D vertical MEMS scanner and a 1D horizontal scanner, in another embodiment consistent with the disclosure. Here, first laser source 106a may emit first laser beam 107a as a beam spot rather than a flash. In this example, first transmitter subsystem 150a may include first scanner 108a with a 1D MEMS scanning mirror (e.g., first scanning mirror 110a) that steers the beam spot to different vertical positions. In other words, the 1D MEMS scanning mirror may steer third laser beam 109a in a zig-zag pattern that moves down the vertical length of a first horizontal slice 202a each cycle until its vertical width has been scanned. Then, the 1D horizontal scanner (e.g., mechanical scanner) steers the laser beam to the second horizontal slice. The 1D MEMS scanning mirror steers third laser beam 109a back to the top of the second horizontal slice 202b before scanning down its vertical width. This scanning procedure is performed until the entire frame of first FOV 112a (e.g., which is the sum of all horizontal slices 202a, 202b . . . 202n) is scanned. Each horizontal slice is associated with one cycle of the scanning procedure for a frame.

When LiDAR system 100 is configured to perform the second exemplary scanning pattern 215 depicted in FIG. 2B, photodetector(s) 120 may be a single photodetector (e.g., no sub-pixelization) with dimensions that are less than or equal to the size of the beam spot emitted by laser source 106a. On the other hand, when LiDAR system 100 is configured to perform the third exemplary scanning pattern 230 depicted in FIG. 2C, photodetector(s) 120 may be a photodetector array that utilizes sub-pixelization. When sub-pixelization is utilized, the diameter of the beam spot emitted by first laser source 106a may be larger than when sub-pixelization is not used. Thus, the beam spot associated with the third exemplary scanning pattern 230 depicted in FIG. 2C may be larger than the beam spot associated with the second exemplary scanning pattern 215 depicted in FIG. 2B. One benefit of using a larger beam spot and/or sub-pixelization is that the MEMS frequency used to resonate the 1D MEMS scanning mirror during the scanning procedure may be lowered.

Referring to FIGS. 1A and 3A, second FOV 112b may be scanned using a 1D vertical flash and a 1D horizontal scanner. Here, second laser source 106b may emit second laser beam 107b as a flash. Rather than being a point of light, second laser beam 107b may have a vertical width of, e.g., 5°, which covers the entire vertical width of second FOV 112b. During, a second optical sensing procedure, second laser source 106b may emit a single flash pulse during each frame cycle to scan second FOV 112b. Then, the mechanical scanner (e.g., polygon scanner 130 in FIG. 1A) steers the flash pulse so that it illuminates a different horizontal slice 302 (e.g., 0.1° in the horizontal direction) of second FOV 112b until the entire second FOV 112b is scanned. In the example depicted in FIG. 3A, the size of the horizontal slice 302 (and the flash pulse) illuminated by the flash pulse may be 5° in the vertical direction and 0.1° in the horizontal direction. In this embodiment, photodetector array(s) 120 may be a 2D detector array that has the same or smaller dimensions than second laser beam 107b. The 2D detector array may include sub-pixelization. In this example, second transmitter subsystem 150b may not include second scanner 108b or second scanning mirror 110b for the same or similar reasons as described above in connection with FIG. 2A.

Referring to FIGS. 1A and 3B, second FOV 112b may be scanned using 1D vertical MEMS scanner and a 1D horizontal scanner, in another embodiment consistent with the disclosure. Here, second laser source 106b may emit second laser beam 107b as a beam spot rather than a flash. In this example, second transmitter subsystem 150b may include second scanner 108b with a 1D MEMS scanning mirror (e.g., second scanning mirror 110b) that steers the beam spot to different vertical positions. In other words, the 1D MEMS scanning mirror may steer fourth laser beam 109b in a zig-zag pattern that moves down the vertical length of a first horizontal slice 302a each cycle until its vertical width has been scanned. In other words, the 1D MEMS scanning mirror may steer laser beam 109a in a zig-zag pattern that moves down the vertical length of a first horizontal slice 302a each cycle until its vertical width has been scanned. Then, the 1D horizontal scanner (e.g., mechanical scanner) steers the laser beam to the second horizontal slice 302b. At the beginning of the new cycle, the 1D MEMS scanning mirror steers fourth laser beam 109b back to the top of the second horizontal slice 302b before scanning down its vertical width. This scanning procedure is performed until the entire frame of second FOV 112b (e.g., which is the sum of all horizontal slices 302a, 302b . . . 302n) is scanned. Each horizontal slice is associated with one cycle. When LiDAR system 100 is configured to perform the fifth exemplary scanning pattern 315 depicted in FIG. 3B, photodetector(s) 120 may be a 1D horizontal photodetector array with, e.g., 10 pixels.

Referring to FIGS. 1A and 3C, second FOV 112b may be scanned using a 2D MEMS scanner. The 2D MEMS scanner may include a MEMS scanning mirror configured to steer fourth laser beam 109b in both the vertical and horizontal directions. Thus, in this embodiment, a mechanical scanner may not be used to scan the horizontal direction of second FOV 112b. Here, second laser source 106b may emit second laser beam 107b as a beam spot rather than a flash. In this example, second transmitter subsystem 150b may include second scanner 108b with a 2D MEMS scanning mirror (e.g., second scanning mirror 110b) that steers the beam spot (e.g., fourth laser beam 109b in FIG. 1A) to different vertical and horizontal positions. In other words, the 2D MEMS scanning mirror may steer fourth laser beam 109b in a zig-zag pattern that moves across a vertical row of a first horizontal slice 302a until the entire horizontal length of that row has been scanned. Then, the 2D MEMS scanning mirror steers fourth laser beam 109b down to the vertical position of the next row in first horizontal slice 302a until first horizontal slice 302a has been scanned in its entirety. The 2D MEMS scanning mirror may then steer fourth laser beam 109b back to the top of the second horizontal slice 302b before scanning across each of those rows. This scanning procedure is performed until the entire frame of second FOV 112b (e.g., which is the sum of all horizontal slices 302a, 302b . . . 302n) is scanned. Each horizontal slice may be associated with one cycle. When LiDAR system 100 is configured to perform the sixth exemplary scanning pattern 330 depicted in FIG. 3C, photodetector(s) 120 may be a single photodetector that covers a portion of the vertical width and a portion of the horizontal width of second FOV 112b. For example, the single photodetector may cover 0.5° in the vertical direction and 0.1° in the horizontal direction.

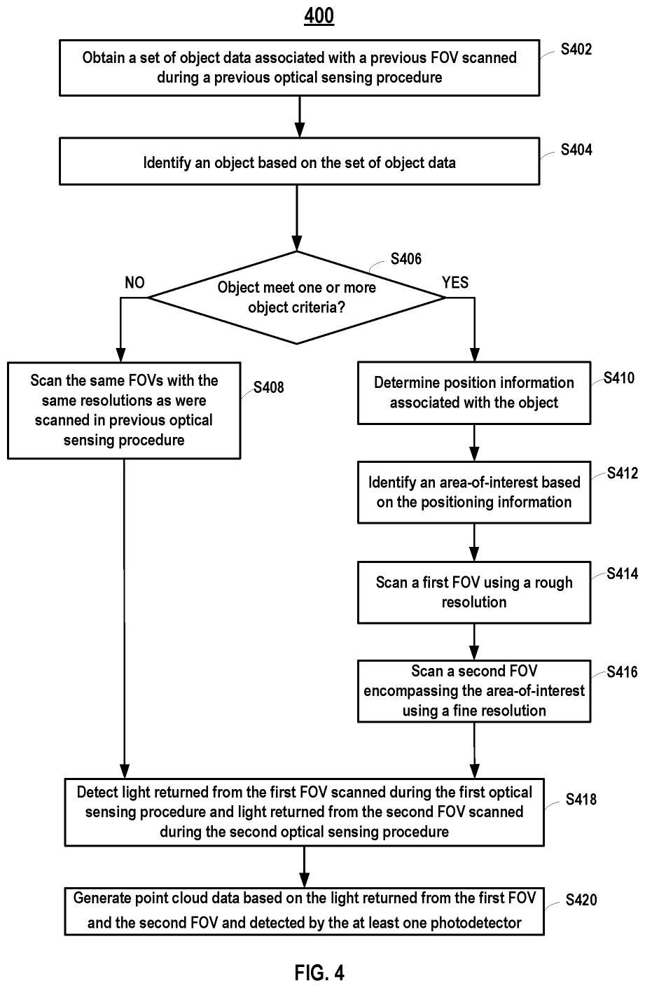

FIG. 4 illustrates a flowchart of an exemplary method 400 of operating a LiDAR system, according to embodiments of the disclosure. Method 400 may be performed by, e.g., LiDAR system 100 of FIG. 1A. Method 400 may include steps S402-S420 as described below. It is to be appreciated that some of the steps may be optional, and some of the steps may be performed simultaneously, or in a different order than shown in FIG. 4.

Referring to FIG. 4, at S402, the LiDAR system may obtain a set of object data associated with a previous FOV (e.g., a third FOV scanned during a third optical sensing procedure prior to the first and second scanning procedure(s) for first FOV 112a and second FOV 112b) scanned during a previous scanning procedure. For example, referring to FIGS. 1A and 1B, the size and location of first FOV 112a and second FOV 112b scanned during a previous scanning procedure are depicted. As shown, second FOV 112b occupies a region in the center of first FOV 112a and corresponds to the area-of-interest of the previous scanning procedure. In the present example, controller 160 may receive/obtain (from signal processor 124) object data 121 associated with the respective first and second point clouds of first FOV 112a and second FOV 112b.

At S404, the LiDAR system may identify an object based on the object data. For example, referring to FIGS. 1A and 1B, controller 160 may perform object detection and/or motion detection based on information included in object data 121. For example, controller 160 may determine based on a group of pixels that share, e.g., the same or similar color, brightness, depth, etc., and the corresponding shape formed by those pixels, that object 170 is a ball.

At S406, the LiDAR system may determine whether the object meets one or more object criteria. For example, referring to FIGS. 1A and 1B, based on the length of a scanning procedure and the position of those pixels associated with object 170 in first FOV 112a, controller 160 may estimate one or more of the acceleration, velocity, and/or trajectory of the ball. Controller 160 may determine whether the one or more object criteria are met by evaluating the object data from multiple scanning procedures performed at a sequence of time points. This may be useful when estimating the acceleration, velocity, and/or trajectory of object 170. In some examples, to identify an object and whether it meets one or more of the object criteria, controller 160 may input object data 121 into a convolutional neural network and/or apply machine learning to object data 121. The convolutional neural network may generate a set of feature maps based on object data 121. Each feature map may be associated with a different one of the object criteria. For example, one feature map may identify the object type (e.g., a ball, a bicycle, a skateboard, a wheelchair, crutches, construction equipment, a pedestrian, a child, a senior citizen, an animal, a vision impaired person, etc.), a second feature map may be used to identify an acceleration of object 170, a third feature map may be used to identify a velocity of object 170, a fourth feature map may be used to identify a trajectory of object 170, etc. Thus, controller 160 may determine whether the one or more object criteria are met based on the feature map(s) output by the convolutional neural network. When it is determined that the object does not meet one or more of the object criteria (S406: No), the operations may move to S408. Otherwise (S406: Yes), when the object meets one or more of the object criteria, the operations may move to S410.

At S408, the LiDAR system may scan the same FOVs of the same size and location as were scanned in the previous scanning procedure. For example, referring to FIGS. 1A and 1B, if object 170 does not meet one or more of the object criteria, first FOV 112a and second FOV 112b of the same size and position as those scanned in a previous scanning procedure may be scanned in the subsequent scanning procedure.

At S410, the LiDAR system may determine position information based on the object. For example, referring to FIGS. 1A and 1B, assume object 170 is identified as a ball and that a ball is an object type that meets that object criterion. In this example, controller 160 may determine the position or the predicted position/trajectory of object 170 during the next scanning procedure.

At S412, the LiDAR system may identify an area-of-interest based on the position information. For example, referring to FIGS. 1A-1C, the area in and/or around the ball (e.g., position information) may be identified as an area-of-interest by controller 160. For example, referring to FIGS. 1A and 1C, assume object 170 is identified as a ball and that a ball is an object type that meets that object criterion. In this example, controller 160 may determine the position or the predicted position/trajectory of object 170 during the next scanning procedure. The area in and/or around the ball (e.g., position information) may be identified as an area-of-interest by controller 160. Thus, controller 160 may cause the position of second FOV 112b to be shifted to this new area-of-interest in the subsequent scanning procedure, as shown in FIG. 1C. With the area-of-interest identified, controller 160 may select the size and position of first FOV 112a and second FOV 112b for the upcoming scanning procedure.

At S414, the LiDAR system may scan the first FOV using a rough-resolution during a first scanning procedure. Controller 160 may send a signal instructing first transmitter subsystem 150a to scan first FOV 112a with the size and position depicted in FIG. 1C.

At S416, the LiDAR system may scan the second FOV using a fine-resolution during a second scanning procedure. Controller 160 may also send a signal instructing second transmitter subsystem 150b to scan second FOV 112b with the size and position depicted in FIG. 1C. Because children sometimes dart into the street chasing after balls, shifting the position of second FOV 112b so that the region of the far-field environment encompassing object 170 may be scanned with greater resolution, thereby increasing the safety and accuracy of autonomous driving safety protocols and decision-making. Although step S414 is illustrated and described prior to step S416, it can be performed prior to or in conjunction with step S416, in certain embodiments.

At S418, the LiDAR system may detect light returned from the first FOV scanned during the first optical sensing procedure and light returned from the second FOV scanned during the second optical sensing procedure. For example, referring to FIG. 1A, photodetector(s) 120 may convert the laser beam 117 collected by lens 114 into an electrical signal 119 (e.g., a current or a voltage signal). In some embodiments, photodetector(s) 120 may include a single photodetector or photodetector array used for receiving laser beams returned from first FOV 112a and second FOV 112b. In some other embodiments, photodetector(s) 120 may include a first photodetector used for receiving laser beams returned from first FOV 112a and a second photodetector used for receiving laser beams returned from second FOV 112b. The type(s) of photodetector(s) 120 included in LiDAR system 100 may depend on the implementation of first transmitter subsystem 150a and second transmitter subsystem 150b.

At S420, the LiDAR system may generate point cloud data based on the light returned from the first FOV and the second FOV and detected by the at least one photodetector. For example, referring to FIG. 1A, signal processor 124 may construct a first point cloud based on the processed information carried by first returned laser beam 111a from first FOV 112a and a second point cloud based on the processed information carried by second returned laser beam 111b from second FOV 112b. The first point cloud may include a first frame, which is a 3D image of the far-field environment encompassed by first FOV 112a at a particular point in time. The second point cloud may include a second frame, which is an image of the far-field environment encompassed by second FOV 112b at a particular point in time. In this context, a frame is the object data/image captured of the far-field environment within a 2D FOV (e.g., horizontal FOV and vertical FOV).

The exemplary LiDAR system 100 described above in connection with FIGS. 1A-4 dynamically selects FOVs of different sizes and resolutions depending on whether an object identified in a previous scanning procedure meets at least one object criteria. Depending on the implementation of LiDAR system 100, controller 160 and/or signal processor 124 may identify the size and location of the FOVs 112a, 112b based on object data 121 obtained from previous optical sensing procedures. The rough-resolution FOV (e.g., first FOV 112a) may be large in size, while the fine-resolution FOV may be comparatively smaller. For an area-of-interest, such as along the horizon where pedestrians, vehicles, or other objects may be located/moving, the fine-resolution FOV (e.g., second FOV 112b) may be used. Moreover, object data 121 obtained from a first pair of rough-resolution and fine-resolution FOVs scanned at a first time (see FIG. 1B) may be used to identify a second pair of rough-resolution and fine-resolution FOVs for scanning at a second time (see FIG. 1C). For instance, when controller 160 and/or signal processor 124 identifies a ball kicked into the street based on object data obtained from a rough-resolution FOV scanned during a first scanning procedure, it may use this object data to identify a new area-of-interest that includes the ball's position and/or trajectory. Thus, during a second scanning procedure, the controller 160 and/or signal processor 124 may shift the position of the fine-resolution FOV (e.g., second FOV 112b) so that the new area-of-interest is scanned with greater resolution, as depicted in FIG. 1C. Selectively identifying different areas-of-interest to scan using fine resolution may achieve a higher-degree of accuracy in terms of object identification and/or motion prediction, and therefore, provide a higher-degree of safety in terms of autonomous navigation decision-making. For the region(s) other than the fine-resolution FOV, e.g., such as the peripheral regions away from the horizon, the rough-resolution FOV may be used. Because the dynamic FOV selection still limits the use of fine resolution scanning/detecting to a relatively small area, a photodetector of reasonable size and a laser beam of reasonable power may still be used to generate a long distance, high-resolution point-cloud for the second FOV.

It is intended that the specification and examples be considered as exemplary only, with a true scope being indicated by the following claims and their equivalents.

What is claimed is:

1. A light detection and ranging (LiDAR) system, comprising:
a first transmitter subsystem;
a second transmitter subsystem;
a controller coupled to the first transmitter subsystem and the second transmitter subsystem and configured to:
identify a first field-of-view (FOV) to be scanned and a second FOV within the first FOV, wherein the second FOV is associated with an area-of-interest;
cause the first transmitter subsystem to scan the first FOV using a first resolution during a first optical sensing procedure; and
cause the second transmitter subsystem to scan the second FOV using a second resolution during a second optical sensing procedure, the second resolution being finer than the first resolution;
at least one photodetector configured to detect light returned from the first FOV scanned during the first optical sensing procedure and light returned from the second FOV scanned during the second optical sensing procedure; and
a signal processor coupled to the at least one photodetector and configured to:
generate point cloud data based on the light returned from the first FOV and the second FOV and detected by the at least one photodetector.

2. The LiDAR system of claim 1, wherein to identify the second FOV, the controller is further configured to:
obtain a set of object data associated with a third FOV scanned during a third optical sensing procedure performed prior to the first optical sensing procedure and the second optical sensing procedure;
identify an area-of-interest based on the set of object data; and
in response to identifying the area-of-interest, identify the second FOV encompassing the area-of-interest.

3. The LiDAR system of claim 2, wherein the controller is further configured to:
cause the second transmitter subsystem to scan the third FOV using the second resolution during the third optical sensing procedure,
wherein the second FOV and the third FOV are associated with different areas-of-interest of a far-field environment.

4. The LiDAR system of claim 2, wherein to identify the second FOV as the area-of-interest based on the set of object data, the controller is configured to:
identify an object based on the set of object data;
determine whether the object meets one or more object criteria;
in response to determining that the object meets the one or more object criteria, determine positioning information of the object; and
identify the second FOV based on the positioning information of the object.

5. The LiDAR system of claim 4, wherein to determine whether the object meets the one or more object criteria, the controller is configured to:
determine whether an acceleration of the object meets an acceleration threshold condition.

6. The LiDAR system of claim 4, wherein to determine whether the object meets the one or more object criteria, the controller is configured to:
determine whether a velocity of the object meets a velocity threshold condition.

7. The LiDAR system of claim 4, wherein to determine whether the object meets the one or more object criteria, the controller is configured to:
determine whether a movement of the object meets a movement condition.

8. The LiDAR system of claim 4, wherein to determine whether the object meets the one or more object criteria, the controller is configured to:
determine whether the object is a pedestrian.

9. The LiDAR system of claim 4, wherein to determine whether the object meets the one or more object criteria, the controller is configured to:
determine whether the object is a child.

10. The LiDAR system of claim 1, to generate the point cloud data, the signal processor is further configured to:
generate the point cloud data corresponding to the second FOV using a signal generated based on the light returned from the second FOV during the second optical sensing procedure; and
generate the point cloud data corresponding to a remaining area of the first FOV using the signal returned from the first FOV during the first optical sensing procedure.

11. The LiDAR system of claim 1, to generate the point cloud data, the signal processor is further configured to:
receive, from the photodetector, a signal associated with the light returned from the first FOV during the first optical sensing procedure and the light returned from the second FOV during the second optical sensing procedure;
identify a first portion of a signal associated with the light returned from the first FOV during the first optical sensing procedure that corresponds to the second FOV;
generate a concatenated signal by combining the first portion of the signal with a second portion of the signal associated with the light returned from the second FOV during the second optical sensing procedure; and
generate the point cloud data corresponding to the second FOV using the concatenated signal.

12. A transmitter for a light detection and ranging (LiDAR) system, comprising:
a first transmitter subsystem;
a second transmitter subsystem;
a controller coupled to the first transmitter subsystem and the second transmitter subsystem and configured to:
identify a first field-of-view (FOV) to be scanned and a second FOV within the first FOV, wherein the second FOV is associated with an area-of-interest;
cause the first transmitter subsystem to scan the first FOV using a first resolution during a first optical sensing procedure; and
cause the second transmitter subsystem to scan the second FOV using a second resolution during a second optical sensing procedure, the second resolution being finer than the first resolution.

13. The transmitter of claim 12, wherein to identify the second FOV, the controller is further configured to:
obtain a set of object data associated with a third FOV scanned during a third optical sensing procedure performed prior to the first optical sensing procedure and the second optical sensing procedure;
identify an area-of-interest based on the set of object data; and
in response to identifying the area-of-interest, identify the second FOV encompassing the area-of-interest.

14. The transmitter of claim 13, wherein the controller is further configured to:
cause the second transmitter subsystem to scan the third FOV using the second resolution during the third optical sensing procedure,
wherein the second FOV and the third FOV are associated with different areas-of-interest of a far-field environment.

15. The transmitter of claim 13, wherein to identify the second FOV as the area-of-interest based on the set of object data, the controller is configured to:
identify an object based on the set of object data;
determine whether the object meets one or more object criteria;
in response to determining that the object meets the one or more object criteria, determine positioning information of the object; and
identify the second FOV based on the positioning information of the object.

16. The transmitter of claim 15, wherein the one or more object criteria includes at least one of an acceleration threshold condition, a velocity threshold condition, or a movement condition.

17. The transmitter of claim 15, wherein to determine whether the object meets the one or more object criteria, the controller is configured to:
determine whether the object is one or more of a pedestrian or a child.

18. A method of operating a light detection and ranging (LiDAR) system, comprising:
identifying, by a controller, a first field-of-view (FOV) to be scanned and a second FOV within the first FOV, wherein the second FOV is associated with an area-of-interest;
causing, by the controller, a first transmitter subsystem to scan the first FOV using a first resolution during a first optical sensing procedure;
causing, by the controller, a second transmitter subsystem to scan the second FOV using a second resolution during a second optical sensing procedure, the second resolution being finer than the first resolution;
detecting, by at least one photodetector, light returned from the first FOV scanned during the first optical sensing procedure and light returned from the second FOV scanned during the second optical sensing procedure; and
generating, by a signal processor, point cloud data based on the light returned from the first FOV and the second FOV and detected by the at least one photodetector.

19. The method of claim 18, further comprising:
obtaining a set of object data associated with a third FOV scanned during a third optical sensing procedure performed prior to the first optical sensing procedure and the second optical sensing procedure;
identifying an area-of-interest based on the set of object data; and
in response to identifying the area-of-interest, identifying the second FOV encompassing the area-of-interest.

20. The method of claim 18, wherein the identifying the second FOV as the area-of-interest based on the set of object data comprises:
identifying an object based on the set of object data;
determining whether the object meets one or more object criteria;
in response to determining that the object meets the one or more object criteria, determining positioning information of the object; and
identifying the second FOV based on the positioning information of the object.
